(19) United States
(12) Patent Application Publication
(10) Pub. No.: US 2011/0125922 A1
(43) Pub. Date: May 26, 2011

(54) METHOD AND APPARATUS FOR SETTING ROUTING PATH IN WIRELESS SENSOR NETWORK

(76) Inventors: Hoon Jeong, Daejeon-city (KR); Jong-Oh Lee, Daejeon-city (KR); Jong-Young Lee, Daejeon-city (KR); Bong-Soo Kim, Daejeon-city (KR); Jong-Suk Chae, Daejeon-city (KR)

(21) Appl. No.: 12/808,522

(22) PCT Filed: Jul. 9, 2008
(86) PCT No.: PCT/KR08/04023

§ 371 Date: Jun. 16, 2010

(30) Foreign Application Priority Data
Dec. 17, 2007 (KR) 10-2007-0132727

(51) Int. Cl. G06F 15/173

(52) U.S. Cl. 709/244

(57) ABSTRACT

Provided are a method and apparatus for setting a routing path in a wireless sensor network. The apparatus for setting a routing path includes a neighbor table storing information of a peripheral device within wireless communication distance of a transmitter transmitting data; a searching unit sequentially searching whether at least one of an address of a destination, a parent address or ancestor address of the destination representing an address of a receiver receiving data transmitted by the transmitter exists or not in the neighbor table; and a link quality indicator (LQI) judging unit transmitting the data to the receiver when a LQI value of the address is greater than a value that is previously set in a case in which an address is searched in the searching unit.

### CROSS-REFERENCE TO RELATED PATENT APPLICATION

This application claims the benefit of Korean Patent Application No. 10-2007-0132727, filed on Dec. 17, 2007, in the Korean Intellectual Property Office, the disclosure of which is incorporated herein in its entirety by reference.

### BACKGROUND OF THE INVENTION

1. Field of the Invention

The present invention relates to an efficient method of setting a routing path from a source address to a destination of data in a wireless sensor network.

The present invention is derived from a research project supported by the Information Technology (IT) Research & Development (R&D) program of the Ministry of Information and Communication (MIC) and the Institute for Information Technology Advancement (IITA) [2005-S-038-03, UHF RF-ID and Ubiquitous Networking Technology Development].

2. Description of the Related Art

Methods of determining a path from a source address to a destination address of data in a conventional wireless sensor network system can be classified into two types.

In a first method, a path is found up to a final destination address through a communication between a parent device and a child device by using only an address assignment method without using a separate path searching message.

As the first method does not use a separate path searching message, a very simple algorithm can be used to embody the method. However, the method should have many transmission paths in order to transmit data to an adjacent device.

In a second method, a path is found to a final destination address by broadcasting, to a peripheral device, a message for finding a path up to a separate destination address and by responding to the message.

The second method can find an optimized path from a source address to a destination address of data. However, since a separate path searching message is used, finding a path is time-consuming and a separate table for storing a routing path is required. Accordingly, the second method is limited to use in small wireless sensor networks having small memory capacities.

### SUMMARY OF THE INVENTION

The present invention provides a method of setting a routing path that is shorter than that using only an address assignment method without using a message for searching a separate path, while having only the advantages of the above two methods.

The present invention also provides a method of determining a path up to a final destination by using information of a peripheral device within an operational wireless communication distance of a device existing in a personal area network (PAN) and by using an address assignment method.

According to an aspect of the present invention, there is provided an apparatus for setting a routing path, including: a neighbor table storing information of peripheral devices within an operational wireless communication distance of a transmitter transmitting data; a searching unit sequentially searching whether at least one of an address of a destination, a parent address or an ancestor address of the destination representing an address of a receiver receiving data transmitted by the transmitter exists or not in the neighbor table; and a link quality indicator (LQI) judging unit transmitting the data to the receiver when a LQI value of the address is greater than a value that is previously set in a case in which an address is searched in the searching unit.

According to another aspect of the present invention, there is provided a method of setting a routing path in a wireless sensor network, including: storing information of peripheral devices within wireless communication distance of a transmitter transmitting data in a neighbor table; sequentially searching whether at least one of an address of a destination, a parent address or an ancestor address of the destination representing an address of a receiver receiving data transmitted by the transmitter exists or not in the neighbor table; and judging a LQI transmitting the data to the receiver when a LQI value of the address is greater than a value that is previously set in a case in which an address is searched in the searching unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of an address assignment method according to an address assignment method based on ZigBee;

FIG. 2 is a flowchart of a process for transmitting data to a destination by using a neighbor table of Table 1 in a device in which data to be transmitted to the destination is generated;

FIG. 3 is a flowchart of a process for transmitting data received by the device in FIG. 2 to a final destination;

FIG. 4 is a view of a topology generated according to an address assignment method based on the ZigBee described with reference to FIG. 1 according to an embodiment of the present invention;

FIG. 5 is a view of transmitting data by using only an address assignment method according to an embodiment of the present invention;

FIG. 6 is a view of transmitting data by using information of a peripheral device within wireless communication distance according to an embodiment of the present invention;

FIG. 7 is a view of transmitting data by using information of a peripheral device when a destination device does not exist within wireless communication distance of the device transmitting data and when a parent of a destination address exists according to an embodiment of the present invention;

FIG. 8 is a view of transmitting data generated in a device having an address 5185 in FIG. 4 to a device having an address 10366 by using only an address assignment method according to an embodiment of the present invention;

FIG. 9 is a view of transmitting data generated in the device having an address 5185 in FIG. 4 to the device having the address 10366 by using information of a peripheral device within wireless communication distance according to an embodiment of the present invention; and

FIG. 10 is a view of an internal structure of an apparatus for setting a routing path according to an embodiment of the present invention.

### DETAILED DESCRIPTION OF THE INVENTION

Hereinafter, exemplary embodiments of the present invention will be described in detail with reference to the attached drawings. Like reference numerals designate like elements throughout the specification.

In the description, detailed descriptions of well-known functions and structures may be omitted so as not to hinder the understanding of the present invention.

Also, it will be understood by those skilled in the art that various changes in form and detail may be made therein without departing from the spirit and scope of the invention in order to make the present invention more complete.

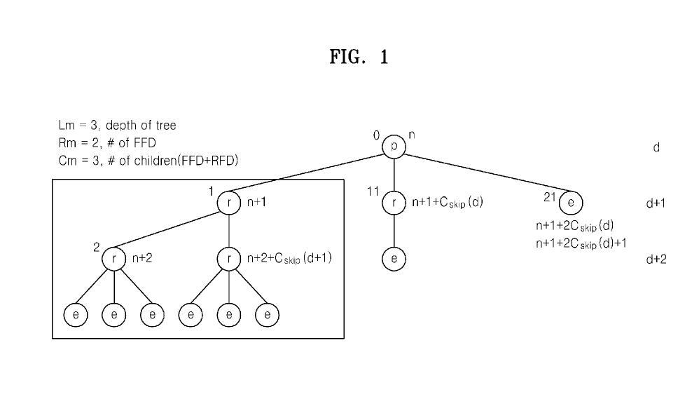

FIG. 1 is a view of an address assignment method according to an address assignment method based on ZigBee.

In FIG. 1, it is assumed that the maximum depth of a tree routing (Lm) is 3, maximum number of children a parent may have (Cm) is 3, and the maximum number of routers a parent may have as its children (Rm) is 2. In this case, Cskip (d) is calculated as follows.

$$Cskip ( d ) = 1 + Cm ( Lm - d - 1 , if Rm = 1 \\ Cskip ( d ) = \frac{\begin{matrix}1 + Cm - Rm - {CmRm}^{Lm - d - 1} \\ 1 - Rm\end{matrix}}{ } , Rm \neq 1 \qquad [ Equation 1 ]$$

In Equation 1, Cskip (d) indicates the size of an address block of devices having a tree routing depth of d. For example, Cskip (1) indicates the size of an address block that a router apparatus accessed to a coordinator may have. Here, the address block indicates the maximum number of the addresses that can be assigned to children. A descendant includes its child device, children (grandson) of the child device, and children of the grandson.

Table 1 shows a neighbor table storing information of peripheral nodes existing within their own wireless communication distance according to a ZigBee standard of the present invention.

TABLE 1
Neighbor Table

| Field Name | Field Type | Valid Range | Description |
|---|---|---|---|
| Extended address | Integer | An extended 64-bit | “64-bit IEEE address that is unique to every device; |
| | | IEEE address | This field shall be present if the neighbor is a parent or |
| | | | child of the device” |
| Network address | Network | 0x0000~0xffff | “The 16-bit network address of the nighboring device. |
| | address | | This field shall be present in every neighbor table entry” |
| Device type | integer | 0x00~0x02 | “The type of the neighbor device |
| | | | 0x00 = ZigBee coordinator |
| | | | 0x01 = ZigBee router |
| | | | 0x02 = ZigBee end device |
| | | | This field shall be present in every neighbor table entry” |
| RxOnWhenIdle | Boolean | TRUE or FALSE | “Indicates if neighbor's receiver is enabled during idle |
| | | | portions of the CAP: |
| | | | TRUE = receiver is on |
| | | | FALSE = receiver is off |
| | | | This field should be present for entries that record the |
| | | | parent or children of a ZigBee router or ZigBee coordinator” |
| Relationship | Integer | 0x00~0x03 | “The relationship between the neighbor and the current |
| | | | device: |
| | | | 0x00 = neighbor is the parent |
| | | | 0x01 = neighbor is a child |
| | | | 0x02 = neighbor is a sibling |
| | | | 0x03 = none of the above |
| | | | 0x04 = previous child |
| | | | This field shall be present in every neighbor table entry” |
| Transmit Failure | Integer | 0x00~0xff | “A value indicating if previous transmissions to the device |
| | | | were successful or not; Higher values indicate more |
| | | | failures. This field shall be present in every neighbor |
| | | | table entry.” |
| LQI | Integer | 0x00~0xff | “The estimated link quality for RF transmissions from this |
| | | | device. This field shall be present in every neighbor table |
| | | | entry.” |
| Incoming beacon | Integer | 0x000000~ | “The time, in symbols, at which the last beacon frame was |
| timestamp | | 0xffffff | received from the neighbor. This value is equal to the |
| | | | timestamp taken when the beacon frame was received. |
| | | | This field is optional” |
| Beacon Transmission | Integer | 0x000000~ | “The transmission time difference, in symbols, between the |
| time offset | | 0xffffff | neighbor's beacon and its parent's beacon. This difference |
| | | | may be subtracted from the corresponding incoming |
| | | | beacon timestamp to calculate the beacon transmission |
| | | | time of the neighbor's oarent. |
| | | | This field is optional” |

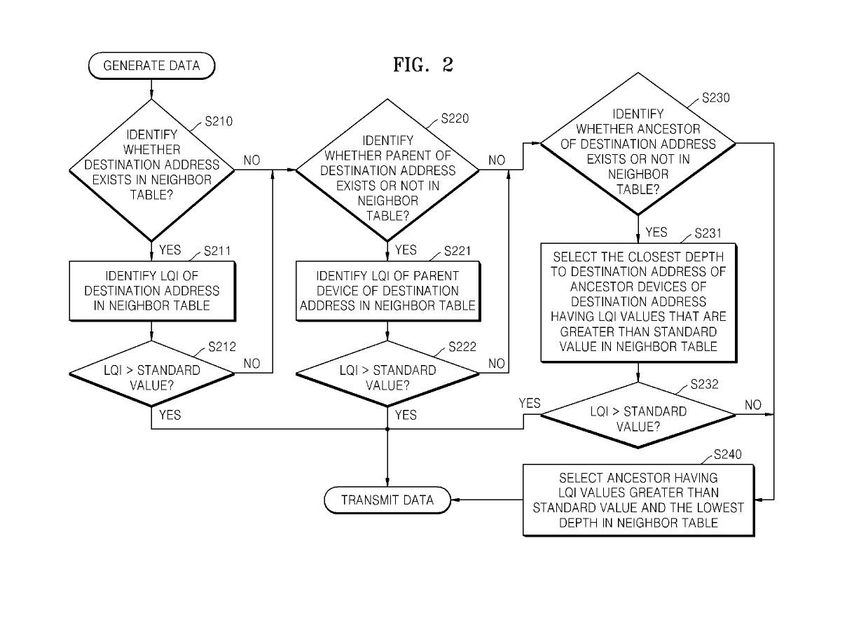

FIG. 2 is a flowchart of a process for transmitting data to a destination by using a neighbor table of Table 1 in a device in which data to be transmitted to the destination is generated.

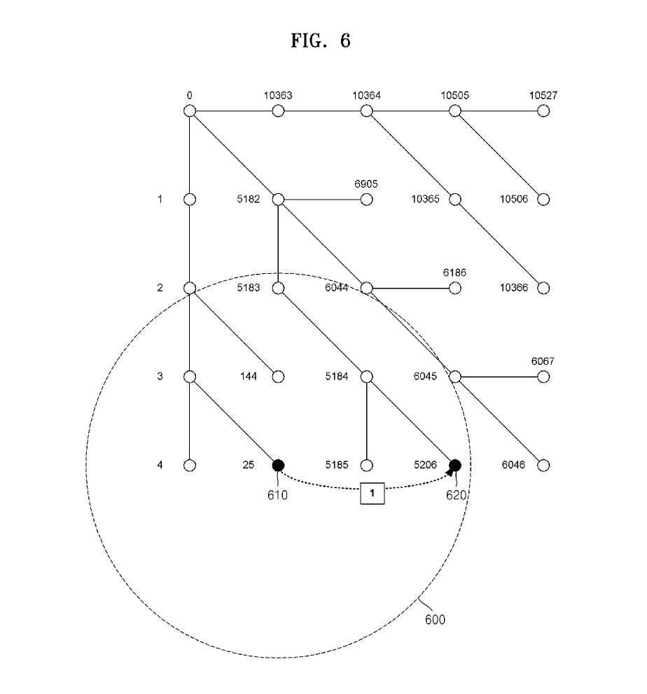

A destination address represents a network address of Table 1. In a device in which data to be transmitted to the destination is generated, first, it is identified whether the same network address as the destination address exists or not in the neighbor table (S210). When the destination address exists in the network table, a link quality indicator (LQI) of the destination address is identified (S211). When the LQI value is greater than a value that is previously set, data is transmitted. This detailed embodiment of the present invention will be described with reference to FIG. 6.

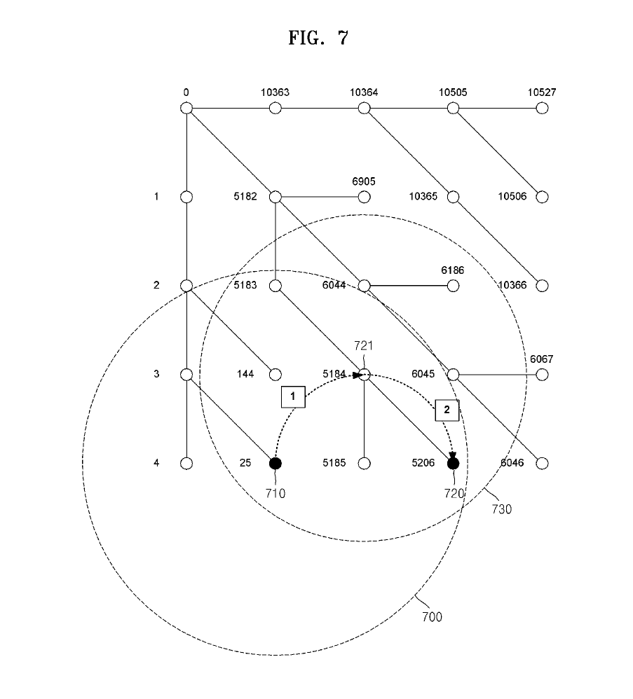

If the same network address as the destination address does not exist in the neighbor table (S210), or if the LQI value is not greater than the value that is previously set in S212, it is identified whether the same network address as a parent device of the destination address exists or not in the neighbor table (S120). Then, a LQI of the parent device of the destination address existing in the neighbor table is identified (S221). If the LQI value is greater than the value that is previously set, data is transmitted. This detailed embodiment of the present invention will be described with reference to FIG. 7.

If the destination address or an address of the destination parent is not found in the neighbor table (S210, S120), it is identified whether an ancestor of the destination address exists or not in the neighbor table (S230). If the ancestor exists in the neighbor table, a depth that is the closest to a destination address of ancestor devices of the destination address having a great LQI of standard values represented by LQI in a Field Name of the neighbor table of Table 1.

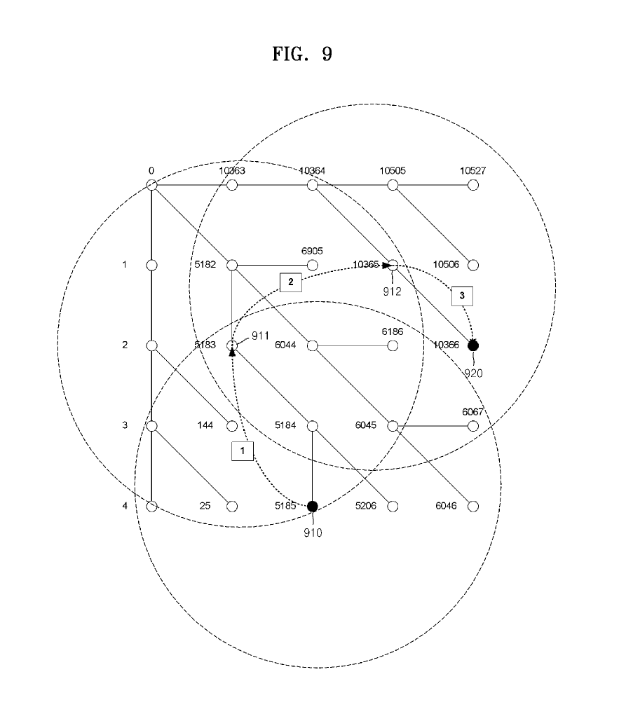

As a result, if any of the destination address, a parent or ancestor of the destination address is not found in the neighbor table, an ancestor having the lowest depth of devices having a greater LQI value than a standard value in the neighbor table is selected (S240), and then data is transmitted. This detailed embodiment of the present invention will be described with reference to FIG. 9.

In FIG. 2, a method of searching a depth of each of assigned addresses uses a program included as an embodiment in Table 2. After a depth of a tree routing of a destination address is calculated by using the program, the depth of the tree routing is calculated with respect to a network address in each neighbor table.

TABLE 2

if( 1<= A <= Lm)

{

Depth = A;

}
else
{

for (i = 0 ; i < Lm ; i+ + )
{

Cskip_temp = Cskip(i);
for ( j = 0 ; j < Rm ; J+ + )
{

if( A > Cskip_temp)
{

A = A − Cskip_temp;

}

}
if(i+ 1 <= A <= i+ 1+ (Cm −Rm))

```
    {
    Depth = A;
  }
```

}
}

In Table 2, A indicates an assigned address, Depth indicates a depth of the assigned address, D indicates the destination address, and Cskip indicates a depth of a tree routing. Here, when A <D<A+Cskip is satisfied, it is identified that the destination address D is a descendant of a device having the address A. If the difference of the depth of the tree routing between the device having the address A and the destination address D is 1, it is identified that the device having the address A is a lineal parent device of the destination address D.

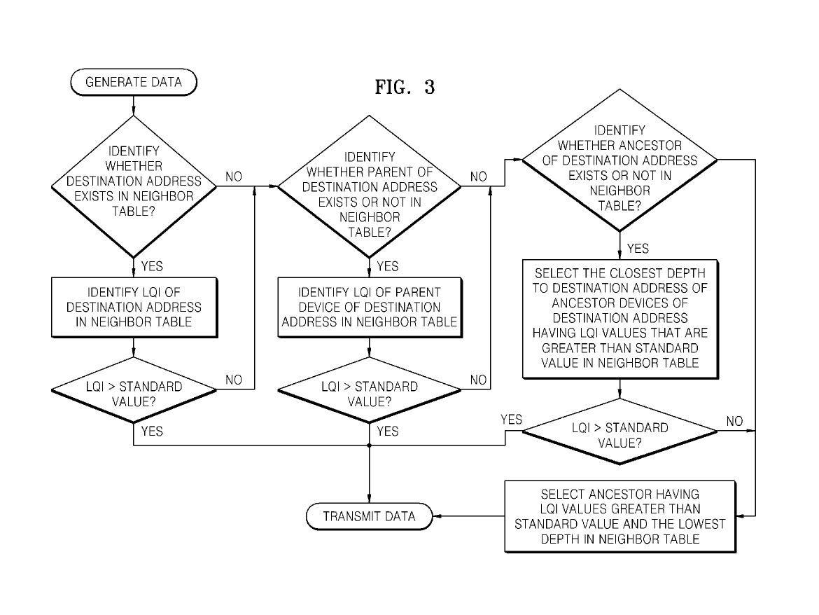

FIG. 3 is a flowchart of a process for transmitting data received by the device in FIG. 2 to a final destination. FIG. 3 illustrates a process in which data is received by actually performing the same process as that of FIG. 2 and then is transferred to the final destination.

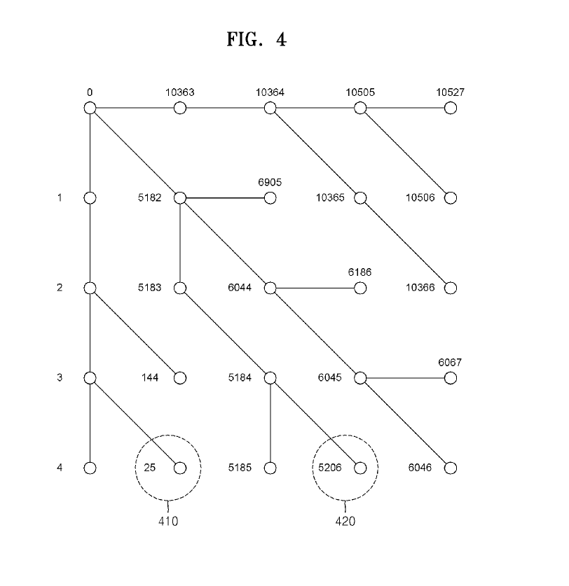

FIG. 4 is a view of a topology generated according to an address assignment method based on the ZigBee described with reference to FIG. 1 according to an embodiment of the present invention. In FIG. 2, the depth of the tree routing is 5, the maximum number of children is 20, and the maximum number of routers is 6.

In the present invention, the case in which a destination device is within wireless communication distance of a device transmitting data will be described on the basis of FIGS. 2 and 3.

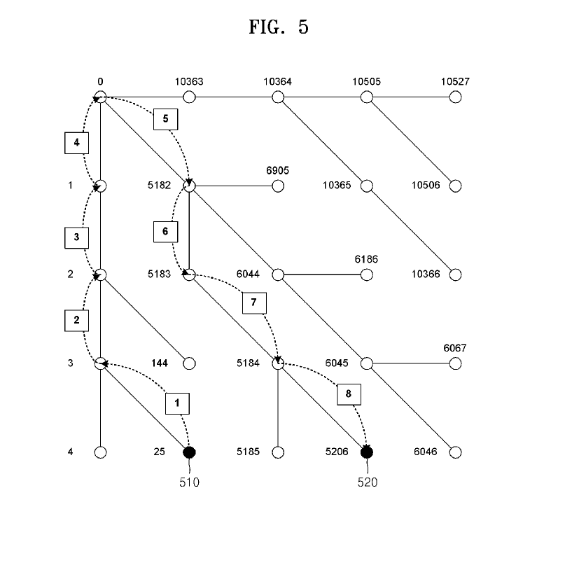

FIG. 5 is a view of transmitting data by using only an address assignment method according to an embodiment of the present invention.

FIG. 4 illustrates the case in which data is transmitted from a device 410 having an address 25 to a device 420 having an address 5206. FIG. 5 illustrates the case in which data is transmitted using only an address assignment method without using a path searching message.

FIG. 6 is a view of transmitting data by using information of a peripheral device within wireless communication distance according to an embodiment of the present invention.

When information of a peripheral device within an operational wireless communication distance is used, data can be transmitted to a short path without using a separate path searching message as illustrated in FIG. 6. In FIG. 6, a circle 600 represents wireless communication distance of a device 610 having an address 25.

Accordingly, since a device 620 having an address 5206 is within the operational wireless communication distance of the device 610 having the address 25, if a LQI value of a neighbor table with respect to the device 620 having the address 5206 is greater than a standard value, the device 610 having the address 25 directly transmits data to the device 620 having the address 5206.

FIG. 7 is a View of transmitting data by using information of a peripheral device when a destination device does not exist within an operational wireless communication distance of the device transmitting data and when a parent of a destination address exists according to an embodiment of the present invention.

FIG. 7 illustrates a case in which data generated in a device 710 having an address 25 is transmitted to a device 720 having an address 5206 similar to FIGS. 5 and 6, however, an operational wireless communication distance 700 of each device is shorter than that of FIGS. 5 and 6.

In this case, a process for transmitting data using only an address assignment method is the same as that of FIG. 5. However, when information of a peripheral device is used, data is transmitted using the same method as that of FIG. 7.

The device 720 having the address 5206 that is a destination device does not exist within an operational wireless communication distance of the device 710 having the address 25. However, if a parent 721 of a destination address exists, data is transmitted using a device 721 having an address 5184.

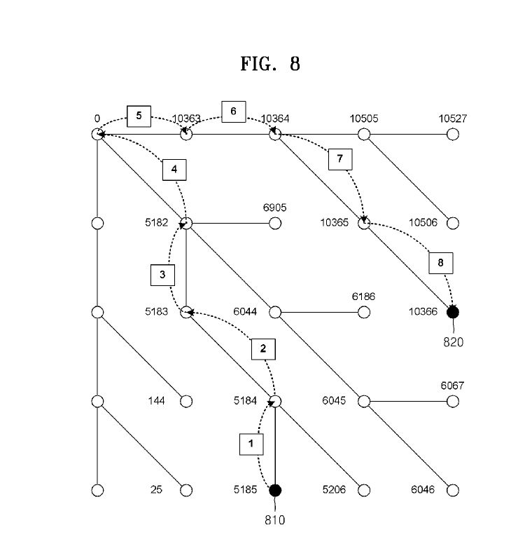

FIGS. 8 and 9 illustrate a process for transmitting data when a destination device, or a parent device or ancestor device of the destination device does not exist in a peripheral device of a device in which data is generated.

FIG. 8 is a view of transmitting data generated in a device having an address 5185 in FIG. 4 to a device having an address 10366 by using only an address assignment method according to an embodiment of the present invention.

FIG. 9 is a view of transmitting data generated in the device having an address 5185 in FIG. 4 to the device having the address 10366 by using information of a peripheral device within wireless communication distance according to an embodiment of the present invention.

Referring to FIG. 9, if any of a destination address, a parent or ancestor of the destination address does not exist in a neighbor table, ancestors 911 and 912 having the lowest depth of devices having a greater LQI value than a standard value are selected in the neighbor table, and then data is transmitted.

A neighbor table “910” includes information of devices having addresses 3, 4, 25, 144, 5183, 5184, 5206, 6044, 6186, 6045, 6067, and 6046. An ancestor device of 10366 that is an address of the destination 920 does not exist in devices having the above addresses.

An ancestor of the address device 910 has two devices having the addresses 5184 and 5183. A depth of the device having the address 5183 is 2, and a depth of the device having the address 5184 is 3. Therefore, the address device 910 selects device 911 that is its own ancestor having the lowest depth in the neighbor table and transmits data.

The device 911 re-searches an address of the destination 920 or an ancestor device of the destination 920 in the neighbor table of device 911. Since the device 912 is a parent device of the destination 920, the device 911 transmits data to the device 912.

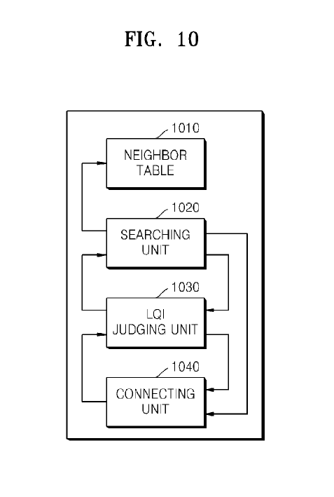

FIG. 10 is a view of an internal structure of an apparatus for setting a routing path according to an embodiment of the present invention.

An apparatus for setting a routing path of the present invention includes a neighbor table 1010, a searching unit 1020, a LQI judging unit 1030, and a connecting unit 1040.

The neighbor table 1010 stores information of a peripheral device within an operational wireless communication distance of a transmitter transmitting data. In this case, an example of the information is shown in Table 1.

The searching unit 1020 and the LQI judging unit 1030 perform a process illustrated in FIGS. 3 and 4. First, it is sequentially searched whether a destination address, a parent address or ancestor address of the destination representing an address of a receiver receiving data transmitted by a transmitter exists or not in the neighbor table 1010.

If the destination address exists in the neighbor table 1010, it is identified whether the LQI value of the destination address is or is not greater than a value that is previously set through the LQI judging unit 1030. If the LQI value of the destination address is greater than the value that is previously set, data is transmitted to the receiver. On the other hand, if the LQI value of the destination address is not greater than the value that is previously set, it is re-searched whether the parent address of the destination that is the next address exists or not in the searching unit 1020.

If the parent address of the destination exists in the searching unit 1020, it is identified whether the LQI value of the destination parent address is or is not greater than the value that is previously set through the LQI judging unit 1030. If the LQI value of the destination parent address is greater than the value that is previously set, data is transmitted to a receiver. If the LQI value of the destination parent address is not greater than the value that is previously set, it is re-searched whether the ancestor address of the destination that is the next address exists or not in the searching unit 1020.

If the ancestor address of the destination exists in the searching unit 1020, it is identified whether the LQI value of the destination ancestor address is or is not greater than the value that is previously set through the LQI judging unit 1030. However, in this case, an address having the closest depth to the destination address of the ancestor addresses of the destination having the LQI value greater than the value that is previously set is selected in the neighbor table.

If the LQI value of the ancestor address of the destination is not greater than the value that is previously set, the connecting unit 1040 selects an ancestor having the lowest depth of addresses having the LQI value greater than the value that is previously set in the neighbor table, and then transmits data.

According to the present invention, by using an address assignment method and communication between a parent device and a child device without using a separate message for searching a path, the problem of a long transmission path being formed when data is transmitted can be solved.

Also, a conventional problem in which it takes a long time to search a path by using a separate path searching message can be solved, and the present invention can be used in a small wireless sensor network having a small memory space.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation.

What is claimed is:

1. An apparatus for setting a routing path, comprising:
a neighbor table storing information of peripheral devices within an operational wireless communication distance of a transmitter transmitting data;
a searching unit sequentially searching whether at least one of an address of a destination, a parent address or an ancestor address of the destination representing an address of a receiver receiving data transmitted by the transmitter exists or not in the neighbor table; and
a link quality indicator (LQI) judging unit transmitting the data to the receiver when a LQI value of the address is greater than a value that is previously set in a case in which an address is searched in the searching unit.

2. The device of claim 1, wherein when the LQI value of the address searched in the searching unit does not exceed the value that is previously set in the LQI judging unit, the next address is sequentially searched in the searching unit.

3. The device of claim 1, further comprising:
a connecting unit selecting an ancestor having the lowest depth of addresses having LQI values greater than the value that is previously set in the neighbor table, when any one of the address, the ancestor address, and the parent address of the destinations is not searched in the searching unit.

4. The device of claim 1, wherein when the ancestor address of the destination is searched in the searching unit, an address having the closest depth to the destination address of the ancestor addresses of the destination having an LQI value greater than the value that is previously set in the neighbor table.

5. The device of claim 1, wherein the neighbor table stores information of the peripheral device according to an address assignment method based on ZigBee and a ZigBee standard.

6. A method of setting a routing path in a wireless sensor network, comprising:
storing information of peripheral devices within wireless communication distance of a transmitter transmitting data in a neighbor table;
sequentially searching whether at least one of an address of a destination, a parent address or an ancestor address of the destination representing an address of a receiver receiving data transmitted by the transmitter exists or not in the neighbor table; and
judging a LQI transmitting the data to the receiver when a LQI value of the address is greater than a value that is previously set in a case in which an address is searched in the searching unit.

7. The method of claim 6, wherein when the LQI value of the address searched in the searching operation is not greater than the value that is previously set, the next address is sequentially searched in the searching operation.

8. The method of claim 6, further comprising:
selecting an ancestor having the lowest depth of addresses having LQI values greater than the value that is previously set in the neighbor table, when any one of the address, the ancestor address, and the parent address of the destinations is not searched in the searching operation.

9. The method of claim 6, wherein when the ancestor address of the destination is searched in the searching operation, an address having the closest depth to the destination address of the ancestor addresses of the destination having an LQI value greater than the value that is previously set in the neighbor table.

10. The method of claim 6, wherein the neighbor table stores information of the peripheral device according to an address assignment method based on ZigBee and a ZigBee standard.
